(19) United States
(12) Patent Application Publication
(10) Pub. No.: US 2026/0367602 A1
(43) Pub. Date: Nov. 19, 2026

(54) CONTROL APPARATUS AND COMPUTER-READABLE RECORDING MEDIUM

(71) Applicant: FANUC CORPORATION, Yamanashi (JP)

(72) Inventors: Hiroshi MATSUMOTO, Yamanashi (JP); Akira KANEMARU, Yamanashi (JP)

(21) Appl. No.: 19/137,629

(22) PCT Filed: Dec. 19, 2022
(86) PCT No.: PCT/JP2022/046718

§ 371 Date: Jun. 10, 2025

(51) Int. Cl. G05B 19/05

(52) U.S. Cl. CPC G05B 19/058; G05B 2219/15104

(57) ABSTRACT

A control apparatus according to the present disclosure comprises: a device detection unit which detects the attachment of an external device storing user information for authenticating a user and data input/output information that specifies at least one input/output operation for predetermined data, and which reads the user information and the data input/output information; a control status monitoring unit that monitors the control status of an industrial machine to be controlled; an input/output data determination unit that compares the read user information and data input/output information with data access information pertaining to per-user access rights and per-control-status access rights to the predetermined data and determines whether to permit or deny an input/output operation on the predetermined data; and a data input/output unit that executes the input/output operation on the predetermined data on the basis of the result of the determination by the input/output data determination unit.

### RELATED APPLICATIONS

The present application is a National Phase of International Application No. PCT/JP2022/046718 filed Dec. 19, 2022.

### TECHNICAL FIELD

The present disclosure relates generally to a control device and a computer-readable recording medium.

### BACKGROUND ART

Input and output of data to and from a control device that controls an industrial machine is mainly executed by operating a screen or inputting data using keys (see, for example, PTL 1).

### CITATION LIST

### Patent Literature

[PTL 1] Japanese Patent Application Publication No. 2015-114821

### BRIEF DESCRIPTION OF DRAWINGS

FIG. 1 is a schematic hardware configuration diagram of a control device according to a first embodiment.

FIG. 2 is a block diagram showing schematic functions of the control device according to the first embodiment.

FIG. 3 is a data diagram showing an example of data input/output information.

FIG. 4 is a flowchart showing a flow of schematic processing of a device detection unit.

FIG. 5 is a table diagram showing an example of data access information stored in a data access information storage unit.

FIG. 6 is a flowchart showing a flow of schematic processing of an input/output data determination unit.

FIG. 7 is a block diagram showing schematic functions of a control device according to a second embodiment.

FIG. 8 is a table diagram showing an example of data access information stored in a data access information storage unit.

FIG. 9 is a table diagram showing an example of data access information for each control state.

FIG. 10 is a block diagram showing schematic functions of a control device according to a third embodiment.

FIG. 11 is a data diagram showing an example of information related to input/output results.

FIG. 12 is a data diagram showing an example of data input/output information.

### DETAILED DESCRIPTION

According to the disclosure, when inputting data during machine start-up or outputting data for failure investigation, there are cases where incorrect data is input or output due to incorrect operations. In addition, an input/output operation itself is extremely time-consuming. When a data input/output operation cannot be performed due to a failure of a display screen or a key input device, a network interruption, or the like, it is not possible to input start-up data (or recovery backup data) or output investigation data. Although there are technologies such as Windows AutoRun that automatically execute a specified program when an external device is recognized, these are not technologies that eliminate the need for operation itself, and there are cases where the program is executed without considering user permissions.

For this reason, there is a demand for a function that allows data to be easily input and output while considering user permissions.

A control device of an industrial machine according to the present disclosure solves the above-mentioned problems by providing a function for automatically executing data input/output for the control device in accordance with various information in an external device when the external device including user information and data input/output information is attached to the control device.

An aspect of the present disclosure is a control device that includes a device detection unit configured to detect installation of an external device that stores user information for authenticating a user and data input/output information specifying at least one input/output operation for predetermined data and to read the user information and the data input/output information, a control state monitoring unit configured to monitor a control state of an industrial machine to be controlled, an input/output data determination unit configured to compare the read user information and data input/output information with data access information relating to an access right for each user to the predetermined data and an access right for each control state and to determine whether an input/output operation for the predetermined data is able to be performed, and a data input/output unit configured to execute an input/output operation for the predetermined data on the basis of a determination result of the input/output data determination unit.

### DESCRIPTION OF EMBODIMENTS

Hereinafter, embodiments of the present disclosure will be described together with the drawings.

### First Embodiment

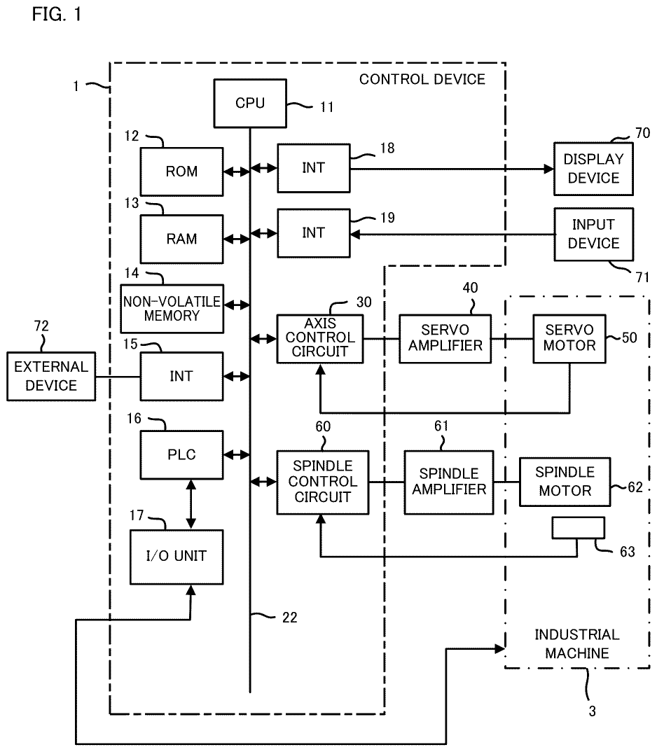

FIG. 1 is a schematic hardware configuration diagram showing main parts of a control device according to an embodiment of the present disclosure. A control device 1 of the present disclosure can be implemented as a control device that controls an industrial machine such as a machine tool or a robot that has a moving object that moves when driven by a motor. The following describes an example of the control device 1 that controls a machine tool that processes a workpiece by controlling a relative position between a tool and the workpiece.

A CPU 11 included in the control device 1 of the present disclosure is a processor that controls the entire control device 1. The CPU 11 reads a system program stored in a ROM 12 via a bus 22, and controls the entire control device 1 in accordance with the system program. A RAM 13 temporarily stores temporary calculation data, display data, various types of data input from the outside, and the like.

A non-volatile memory 14 is configured with, for example, a memory, a solid state drive (SSD), or the like backed up by a battery (not shown), and a storage state of the non-volatile memory 14 is maintained even when a power supply of the control device 1 is turned off. The non-volatile memory 14 stores control programs and data read from an external device 72 via an interface 15, data and control programs input via an input device 71, and various data acquired from an industrial machine 3. The control programs and data stored in the non-volatile memory 14 may be expanded into the RAM 13 when being executed/used. In the ROM 12, various system programs such as known analysis programs are written in advance.

The interface 15 is an interface for connecting the CPU 11 of the control device 1 to the external device 72 such as a USB memory, a compact flash (registered trademark), or an SD card. For example, a control program and various data used to control the industrial machine 3 can be read from the external device 72 side. In addition, the control program and various data edited in the control device 1 can be stored in the external device 72. A programmable logic controller (PLC) 16 outputs signals to the industrial machine 3 and its peripheral devices (for example, a tool changer, an actuator such as a robot, a sensor attached to the industrial machine 3, and the like) via an I/O unit 17 and controls the signals in accordance with a sequence program built into the control device 1. The PLC 16 also receives signals from various switches and peripheral devices on an operation panel installed in the main body of the industrial machine 3, performs necessary signal processing, and then passes the signals to the CPU 11.

Respective pieces of data read on the memory, data obtained as a result of executing a control program, a system program, and the like are output to and displayed on a display device 70 via an interface 18. In addition, the input device 71 configured with a keyboard, a pointing device, or the like supplies the CPU 11 with a command, data, and the like based on an operation by an operator via an interface 19.

An axis control circuit 30 for controlling the axes of the industrial machine 3 receives an axis movement command value from the CPU 11 and outputs an axis command to a servo amplifier 40. The servo amplifier 40 receives this command and drives a servo motor 50 that moves each moving object of the industrial machine 3 along the axis. The servo motor 50 of the axis has a built-in position/speed detector, and feeds back a position/speed feedback signal received from the position/speed detector to the axis control circuit 30. The axis control circuit 30 performs feedback control of the position/speed of the servo motor 50. Although only one axis control circuit 30, one servo amplifier 40, and one servo motor 50 are shown in the hardware configuration diagram of FIG. 1, in reality, they are provided according to the number of axes provided in the industrial machine 3 to be controlled. For example, when controlling a general machine tool equipped with three linear axes, three sets each including the axis control circuit 30, the servo amplifier 40, and the servo motor 50 are provided to relatively move a spindle to which the tool is attached and a workpiece in the directions of the three linear axis (X-axis, Y-axis, and Z-axis).

A spindle control circuit 60 receives a spindle rotation command and outputs a spindle speed signal to a spindle amplifier 61. The spindle amplifier 61 receives the spindle speed signal and rotates a spindle motor 62 of the industrial machine 3 at a commanded rotation speed to drive the spindle. A position coder 63 is connected to the spindle motor 62. The position coder 63 outputs a feedback pulse in synchronization with the rotation of the spindle, and this feedback pulse is read by the CPU 11.

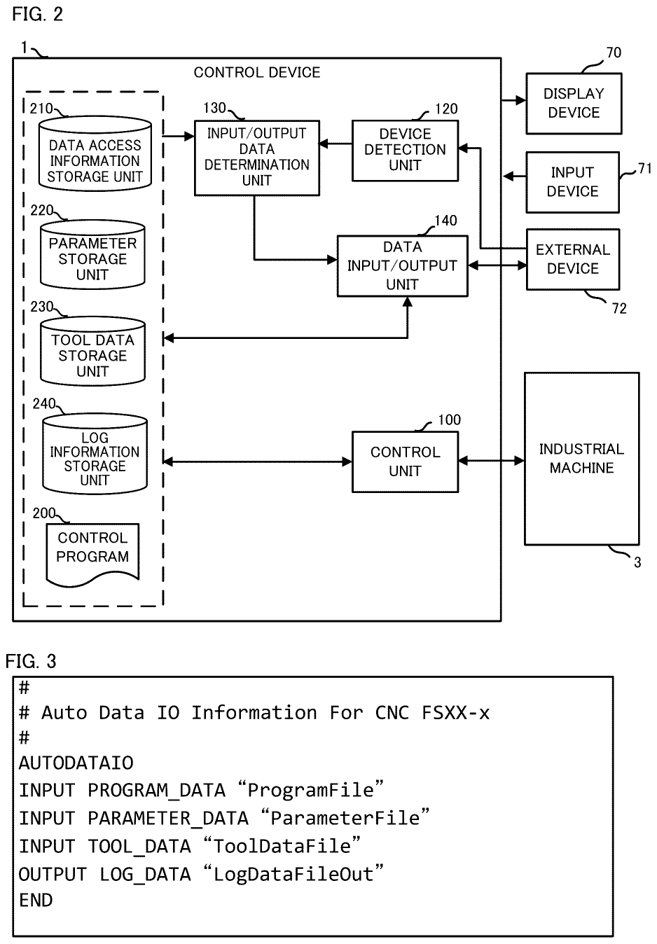

FIG. 2 is a schematic block diagram showing functions of the control device 1 according to the first embodiment of the present disclosure. The respective functions of the control device 1 according to this embodiment are realized by causing the CPU 11 provided in the control device 1 shown in FIG. 1 to execute the system program and controlling the operations of the respective parts of the control device 1.

The control device 1 of this embodiment includes a control unit 100, a device detection unit 120, an input/output data determination unit 130, and a data input/output unit 140. A control program 200 for controlling the industrial machine 3 is also stored in the RAM 13 to the non-volatile memory 14 of the control device 1. Furthermore, the RAM 13 to the non-volatile memory 14 of the control device 1 are provided in advance with a data access information storage unit 210, which is an area for storing data access information related to rights to access data stored in the control device 1, a parameter storage unit 220, which is an area for storing parameters that are set in the control device 1, a tool data storage unit 230, which is an area for storing data related to tools used in the industrial machine 3 controlled by the control device 1, and a log information storage unit 240, which is an area for storing log information related to the operation of the control device 1.

The control unit 100 has general functions required to control the industrial machine 3. The control unit 100 controls the industrial machine 3 on the basis of a given command. For example, the control unit 100 analyzes a given movement command and controls the servo motor 50 that operates the movement axis of the industrial machine 3 on the basis of the analysis result. The control unit 100 also analyzes a given spindle rotation command and controls the spindle motor 62 that operates the spindle of the industrial machine 3 on the basis of the analysis result. A command for controlling the industrial machine 3 may be, for example, a command that is read from the control program 200. The command for controlling the industrial machine 3 may be a command that is input via the input device 71. When controlling the industrial machine 3, the control unit 100 refers to parameters that are set in the parameter storage unit 220 and tool data that is stored in the tool data storage unit 230. The control unit 100 also stores information, alarms, and the like acquired during control of the industrial machine 3 in the log information storage unit 240 together with time information.

The device detection unit 120 detects that the external device 72 has been installed in the control device 1. When the device detection unit 120 detects that the external device 72 has been installed, the device detection unit 120 confirms whether user information and data input/output information are stored in the external device 72. When stored, the device detection unit 120 reads the information and notifies the input/output data determination unit 130.

The user information stored in the external device 72 includes at least information necessary to authenticate a user. The information necessary to authenticate the user may be, for example, a password corresponding to the control device 1 or the industrial machine 3. The information may also be account information that is a set of information for uniquely identifying the user and the password. The information may also be license information issued for a specific user, or the like.

The data input/output information stored in the external device 72 includes at least the specification of data stored by the control device 1 and input/output operations for the data. The input/output operations are input or output operations received from the external device 72 for data stored in the control device 1. Data to be input and output may be specified for each type of data stored in the control device 1. The types of data may be, for example, a machining program, parameters, tool data, log information including alerts, and the like. The data to be input and output may be specified as individual data stored in the control device 1. For example, specific parameters of the control device 1 or a machining program with a predetermined name may be specified. In addition, a predetermined range of data may be specified. For example, log information for a predetermined time period may be specified.

FIG. 3 is a data diagram showing an example of data input/output information. The data input/output information in FIG. 3 shows an example of input and output for each type of data stored in the control device 1. In FIG. 3, information related to input and output of data is written between reserved words “AUTODATAIO” to “END”. A line starting with “INPUT” includes information related to data input operations. Furthermore, a line starting with “OUTPUT” includes information related to data output operations. In the example of FIG. 3, “PROGRAM_DATA” specifies the type of data of a machining program. “PARAMETER_DATA” specifies the type of data of a parameter. “TOOL_DATA” specifies the type of data related to a tool. “LOG_DATA” specifies the type of data related to log information. A line starting with “#” is a comment. In the example of FIG. 3, a line “INPUT PROGRAM_DATA “ProgramFile”” means that a file of “ProgramFile” stored on the external device 72 is input as a machining program for the control device 1. Furthermore, a line “INPUT PARAMETER_DATA “ParameterFile”” means that a file of “ParameterFile” stored on the external device 72 is input as a parameter for the control device 1. A line “INPUT TOOL_DATA “ToolDataFile”” means that a file of “ToolDataFile” stored on the external device 72 is input as data related to a tool for the control device 1. Furthermore, a line “OUTPUT LOG_DATA “LogDataFileOut”” means that log information stored in the control device 1 is output to the external device 72 with a file name of “LogDataFileOut”. The format of each data file may be determined appropriately in accordance with the specifications of the control device 1. The data input/output information shown in FIG. 3 is an example and does not necessarily have to be in this format. Any format may be determined as long as it is possible to specify which data in the control device 1 is to be subjected to an input or output operation.

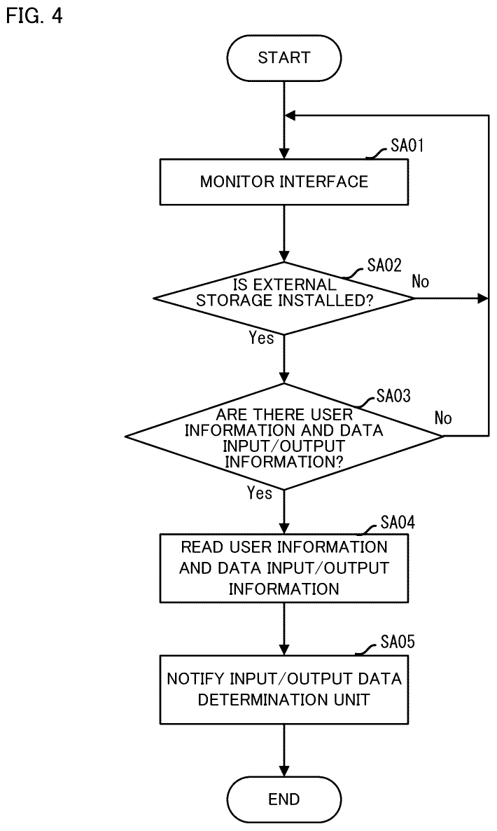

FIG. 4 is a flowchart showing a flow of schematic processing the device detection unit 120. The device detection unit 120 monitors the interface 15 to confirm whether the external device 72 has changed from an uninstalled state to an installed state (step SA01). When the external device 72 remains in an uninstalled state (No in step SA02), the device detection unit 120 continues monitoring the interface 15 (return to step SA01). When the external device 72 has changed to an installed state (Yes in step SA02), the device detection unit 120 confirms whether user information and data input/output information are stored in the installed external device 72 (step SA03).

When they are not stored (No in step SA03), the device detection unit 120 continues monitoring the interface 15 as it is not for inputting and outputting data (return to step SA01). When the user information and the data input/output information are stored (Yes in step SA03), the device detection unit 120 reads the user information and the data input/output information from the external device 72 (step SA04) and notifies the input/output data determination unit 130 of the read user information and data input/output information (step SA05).

The input/output data determination unit 130 authenticates a user on the basis of the information notified of by the device detection unit 120. User authentication is performed by comparing the user information notified of by the device detection unit 120 with data access information stored in the data access information storage unit 210. For example, when information for uniquely identifying a user and a password are used for user authentication, it is determined whether a set of information for uniquely identifying the user and a password included in the user information notified of by the device detection unit 120 is stored in the data access information stored in the data access information storage unit 210. Then, when the set of information for uniquely identifying the user and a password is stored, it may be determined that the user has been authenticated. A user authentication method is not limited thereto, and any known authentication method may be used as appropriate.

Next, the input/output data determination unit 130 analyzes the data input/output information notified by the device detection unit 120, and identifies the content of a specified input/output operation and target data. Then, to the data access information storage unit 210, it is determined whether the specified input/output operation is permitted for the target data. When the user is permitted to perform an input/output operation on specified data, the input/output data determination unit 130 notifies the data input/output unit 140 of the content of the permitted input/output operation. The content of an input/output operation that is not permitted is discarded without being notified to the data input/output unit 140.

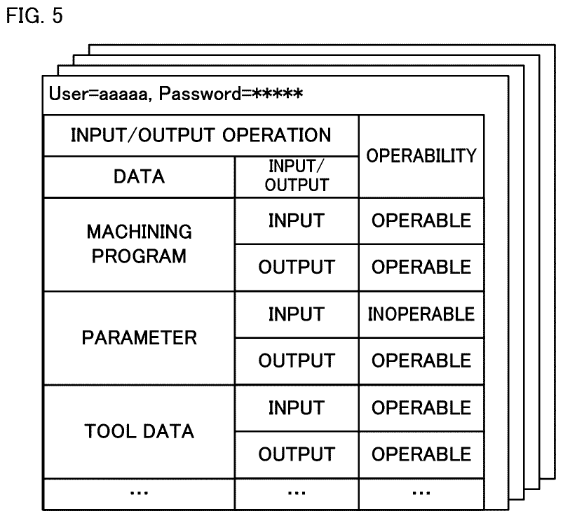

FIG. 5 is a table diagram showing an example of data access information stored in the data access information storage unit 210. In the example of FIG. 5, the data access information defines access rights for input/output operations on data for each authenticated user. For example, an authenticated user “aaaaa” is permitted to perform output operations on parameters of the control device 1. In addition, input operations on the parameters are set not to be able to be performed. With reference to such data access information, the input/output data determination unit 130 determines whether input/output operations can be performed for data specified from the data input/output information.

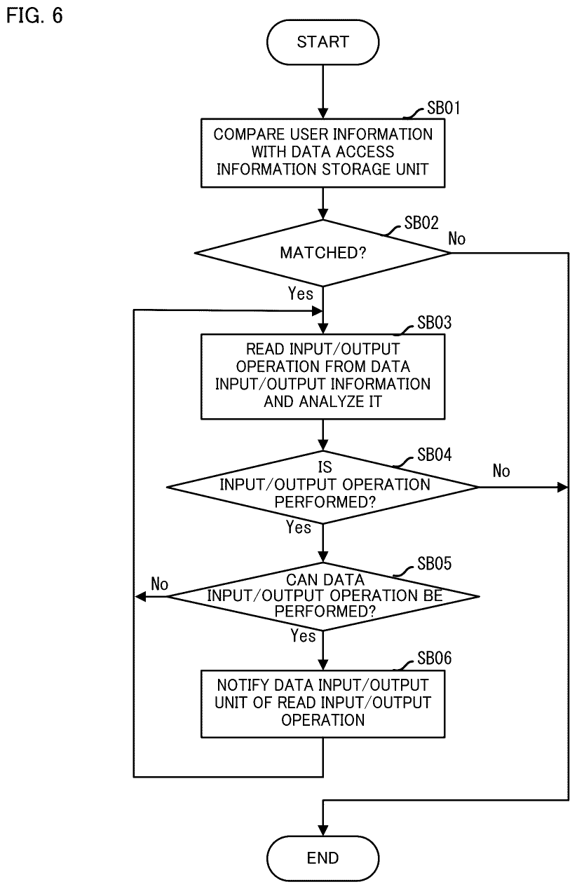

FIG. 6 is a flowchart showing a flow of schematic processing of the input/output data determination unit 130. When the input/output data determination unit 130 is notified of user information and data input/output information by the device detection unit 120, the input/output data determination unit 130 compares the user information with the data access information storage unit 210 (step SB01). When the data access information that matches the user information is not stored in the data access information storage unit 210 (No in step SB02), the input/output data determination unit 130 ends the processing. On the other hand, when the data access information that matches the user information is stored in the data access information storage unit 210 (Yes in step SB02), the input/output data determination unit 130 reads the next input/output operation from the data input/output information and analyzes it (step SB03). At this time, when no input/output operation remains in the data input/output information (No in step SB04), the input/output data determination unit 130 ends the processing. When the input/output operation can be read and analyzed (Yes in step SB04), the input/output data determination unit 130 determines whether the user is permitted to perform input/output operations on the analyzed data (step SB05). When the user is not permitted (No in step SB05), the processing proceeds to step SB03. When the user is permitted (Yes in step SB05), the data input/output unit 140 is notified to execute input/output operations on the data (step SB06). Then, the processing proceeds to step SB03.

The data input/output unit 140 allows the control device 1 to input and output data between the RAM 13, the non-volatile memory 14, and the external device 72, on the basis of the input/output operations for the data notified by the input/output data determination unit 130. When an input operation for data is specified, the data input/output unit 140 reads the specified data from the external device 72 and stores it in the corresponding areas of the RAM 13 and the non-volatile memory 14 of the control device 1. When an output operation for data is specified, the data input/output unit 140 reads the specified data from the corresponding areas of the RAM 13 and the non-volatile memory 14 of the control device 1 and stores it in the external device 72.

The control device 1 according to this embodiment with the above configuration can prevent erroneous operations when inputting data at the start-up of the industrial machine 3 or when outputting data for failure investigation. In addition, time-consuming input/output operations can be omitted, and in particular, even when data input/output operations cannot be performed due to a failure of a display screen or a key input device, a network interruption, or the like, it is possible to input start-up data and output investigation data. Furthermore, data can be input and output according to the user's authority by making it possible to input and output data on the basis of user information.

### Second Embodiment

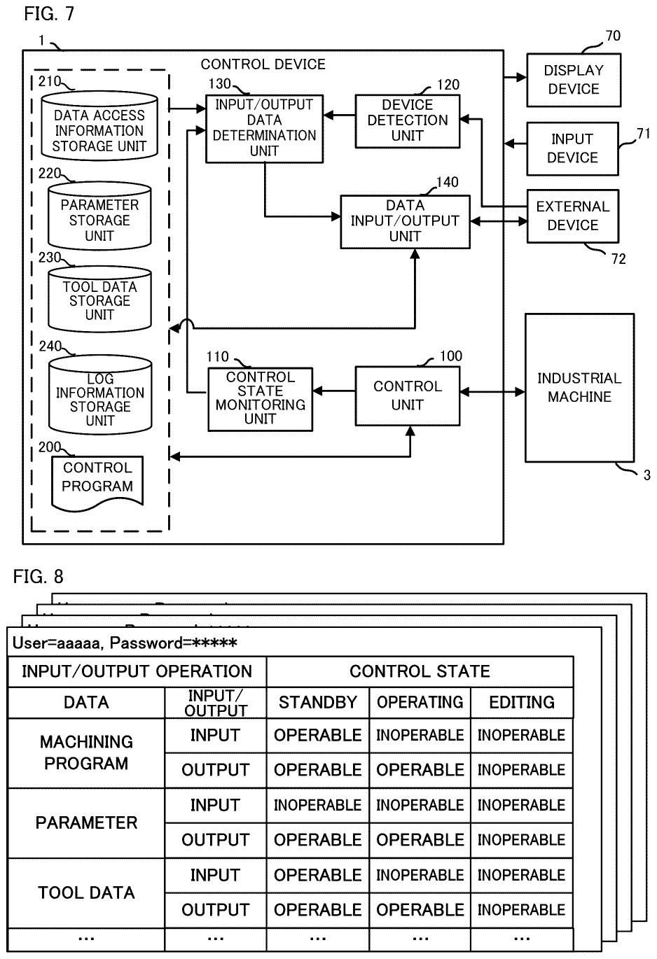

FIG. 7 is a schematic block diagram showing functions of a control device 1 according to a second embodiment of the present disclosure. The functions of the control device 1 according to this embodiment are realized by causing the CPU 11 of the control device 1 shown in FIG. 1 to execute a system program and control the operation of each part of the control device 1, as in the control device 1 according to the first embodiment.

The control device 1 of this embodiment further includes a control state monitoring unit 110 in addition to the control unit 100, a device detection unit 120, an input/output data determination unit 130, and a data input/output unit 140. A control program 200 for controlling an industrial machine 3 is stored in a RAM 13 to a non-volatile memory 14 of the control device 1. Furthermore, the RAM 13 to the non-volatile memory 14 of the control device 1 are provided in advance with a data access information storage unit 210, which is an area for storing data access information regarding whether to access data stored in the control device 1, a parameter storage unit 220, which is an area for storing parameters that are set in the control device 1, a tool data storage unit 230, which is an area for storing data related to tools used in the industrial machine 3 controlled by the control device 1, and a log information storage unit 240, which is an area for storing log information related to the operation of the control device 1.

The control unit 100, the device detection unit 120, and the data input/output unit 140 provided in the control device 1 according to this embodiment have functions similar to those of the control unit 100, the device detection unit 120, and the data input/output unit 140 provided in the control device 1 according to the first embodiment.

The control state monitoring unit 110 monitors the control state of the industrial machine 3 and notifies the input/output data determination unit 130 of the control state. The control state of the industrial machine 3 includes states related to the operation of the industrial machine 3, such as standby, operating, and the like. The control state of the industrial machine 3 also includes states related to access to each piece of data such as machining programs and parameters.

Similarly to the input/output data determination unit 130 according to the first embodiment, the input/output data determination unit 130 according to this embodiment authenticates a user based on user information notified of by the device detection unit 120 and analyzes data input/output information. Then, it is determined whether an input/output operation specified by the data input/output information is permitted. When performing this determination, the input/output data determination unit 130 according to this embodiment determines whether the input/output operation is permitted on the basis of the control state of the industrial machine 3. The control state of the industrial machine 3 is notified of by the control state monitoring unit 110. When the user is permitted to perform an input/output operation on the specified data in the current operating state of the industrial machine 3, the input/output data determination unit 130 notifies the data input/output unit 140 of the contents of the permitted input/output operation. The content of non-permitted input/output operation is discarded without being notified to the data input/output unit 140.

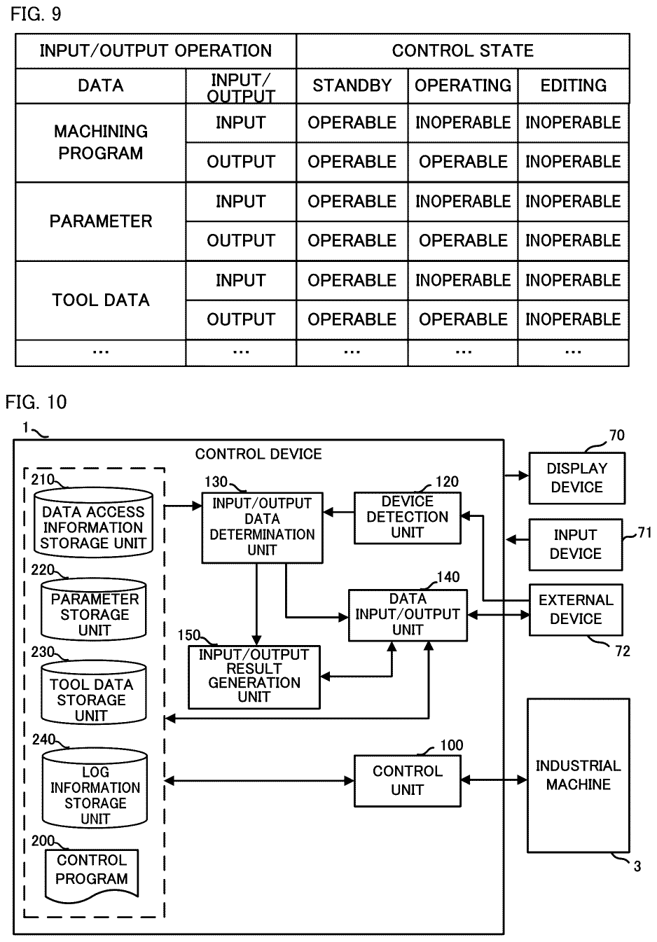

FIG. 8 is a table diagram showing an example of data access information stored in the data access information storage unit 210. In the example of FIG. 8, the data access information defines whether an input/output operation can be performed on data for each authenticated user. Further, in the example of FIG. 8, for each piece of data, whether an input/output operation can be performed on data for each control state of the industrial machine 3 is defined. For example, an authenticated user “aaaaa” is permitted to perform output operations on the parameters of the control device 1 when the control state of the industrial machine 3 is “standby” and “operating”, but is not permitted to perform an output operation when the parameter data is “editing”. In addition, input operations on the parameters are set not to be able to be performed. With reference to such data access information, the input/output data determination unit 130 determines whether input/output operations can be performed for data specified from the data input/output information. Whether an input/output operation can be performed on data for each control state is common to all users. For this reason, as illustrated in FIG. 9, whether an input/output operation can be performed on data for each control state may be set as common data access information. In this configuration, data access information for each user and data access information for each control state, as illustrated in FIG. 5, can be used in combination, and access to data can be permitted only when access to both information is permitted.

The control device 1 according to this embodiment having the above-mentioned configuration can input and output data based on user information and the control state of the industrial machine 3, and thus it is possible to input and output data taking into consideration safety according to the user's authority and control state.

As a modification example of the control device 1 according to this embodiment, when there is data for which it is determined that an input/output operation cannot be performed due to the control state of the industrial machine 3, the input/output data determination unit 130 may wait to notify the data input/output unit 140 of the content of the input/output operation until a control state in which an input/output operation can be performed is set. Then, when the control state of the industrial machine 3 notified by the control state monitoring unit 110 becomes a state where an input/output operation for the data can be performed, the input/output data determination unit 130 notifies the data input/output unit of the content of the input/output operation for the data. For example, it is assumed that data access information for each user shown in FIG. 5 is set, and data access information for each control state shown in FIG. 9 is set. At this time, it is assumed that the user “aaaaa” attempts to input a machining program while the industrial machine 3 is operating. In this case, it is understood from the data access information of the user that the user “aaaaa” can input a machining program, but from the data access information of the control state that the machining program cannot be input during “operation”. In such a case, rather than immediately denying access because the machining program cannot be input, the input of data is awaited until the control state of the industrial machine 3 changes to a control state (standby state) where the machining program can be input, and the machining program is input at the point in time when the control state has changed to a control state where the machining program can be input. Whether to wait for an input/output operation depending on the control state may be specified by the data input/output information. FIG. 12 is a data diagram showing an example of data input/output information. The data input/output information shown in FIG. 12 has an option “-w” added to a command for an output operation of log information.

For an input/output operation with such an option added, the industrial machine 3 waits until the control state of the industrial machine 3 allows an input/output operation for the data, and for other input/output operations, the industrial machine 3 does not wait and determines that the input/output operation cannot be performed.

With such a configuration, when an input/output operation cannot be performed due to the control state of the industrial machine 3, a data input/output operation can be executed at an appropriate timing without repeatedly removing and installing the external device 72.

### Third Embodiment

FIG. 10 is a schematic block diagram showing functions of a control device 1 according to a third embodiment of the present disclosure. The functions of the control device 1 according to this embodiment are realized by causing the CPU 11 of the control device 1 shown in FIG. 1 to execute a system program and control the operation of each part of the control device 1, as in the control device 1 according to the first embodiment.

The control device 1 of this embodiment further includes an input/output result generation unit 150 in addition to the control unit 100, a device detection unit 120, an input/output data determination unit 130, and a data input/output unit 140. A control program 200 for controlling an industrial machine 3 is stored in a RAM 13 to a non-volatile memory 14 of the control device 1. Furthermore, the RAM 13 to the non-volatile memory 14 of the control device 1 are provided in advance with a data access information storage unit 210, which is an area for storing data access information regarding whether to access data stored in the control device 1, a parameter storage unit 220, which is an area for storing parameters that are set in the control device 1, a tool data storage unit 230, which is an area for storing data related to tools used in the industrial machine 3 controlled by the control device 1, and a log information storage unit 240, which is an area for storing log information related to the operation of the control device 1.

The control unit 100 and the device detection unit 120 provided in the control device 1 according to this embodiment have functions similar to those of the control unit 100 and the device detection unit 120 provided in the control device 1 according to the first embodiment.

Similarly to the input/output data determination unit 130 according to the first embodiment, the input/output data determination unit 130 according to this embodiment authenticates a user based on user information notified by the device detection unit 120 and analyzes data input/output information. Then, it is determined whether an input/output operation specified by the data input/output information is permitted, and the data input/output unit 140 is notified of the content of the input operation permitted for the user. The input/output data determination unit 130 also notifies the input/output result generation unit 150 of the determination results of the input/output operation.

The input/output result generation unit 150 generates information related to the input and output results on the basis of the results of the determination regarding whether an input/output operation can be performed, the results being notified by the input/output data determination unit 130. Then, the data input/output unit 140 is notified of the generated information related to the input and output results. The information related to the input and output results may include results of input and output of data performed by the data input/output unit 140. For example, when a data output operation fails due to insufficient capacity of the external device 72, that information may be included in the information related to the input and output results.

In this embodiment, the data input/output unit 140 inputs and outputs data between the RAM 13 and non-volatile memory 14 of the control device 1 and the external device 72 on the basis of the input/output operation for the data notified by the input/output data determination unit 130. The data input/output unit 140 also stores information related to the input and output results notified by the input/output result generation unit 150 in the external device 72.

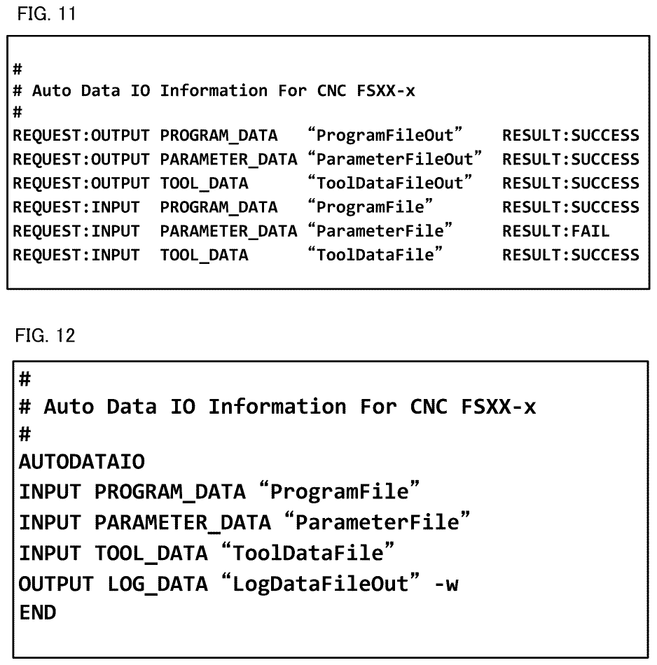

FIG. 11 is a data diagram showing an example of information related to input and output results. The information related to the input and output results includes at least the content of an input/output operation, the type of target data, and information indicating success or failure of the input/output operation. The information related to the input and output results may also include results of input and output of each data by the data input/output unit 140. The information related to the input and output results may further include information related to the control state of the industrial machine 3 at the time of executing an input/output operation, the cause of a failure in an input/output operation, and the like. The information related to the input and output results may be stored in the external device 72 under a predetermined file name. A file name for the information related to the input and output results may be able to be set within predetermined parameters of the control device 1 or within the data input/output information.

The control device 1 according to this embodiment with the above-mentioned configuration can store the results of data input/output processing in the external device 72 as information related to the input and output results. Thereby, it is possible to grasp the success or failure of an input/output operation.

The control device 1 according to each of the above-mentioned embodiments can prevent erroneous operations when inputting data at the start-up of the industrial machine 3 or when outputting data for failure investigation. In addition, time-consuming input/output operations can be omitted, and in particular, even when data input/output operations cannot be performed due to a failure of a display screen or a key input device, a network interruption, or the like, it is possible to input start-up data and output investigation data. Furthermore, data can be input and output according to the user's authority by making it possible to input and output data on the basis of user information.

The present disclosure has been described in detail as above, but is not limited to these embodiments. Thus, various additions, substitutions, modifications, partial deletions and so on may be made to these embodiments without departing from the gist of the disclosure or the spirit of the disclosure as derived from the contents described in the claims and their equivalents. For example, in the above-mentioned embodiments, the order of each operation and the order of each process are shown as examples and are not limited thereto. The same applies when numerical values or formulas are used to explain the above-mentioned embodiments.

In regard to the present disclosure, supplementary notes will be disclosed as below:

### (Supplementary Note 1)

A control device (1) according to one aspect of the present disclosure comprising: a device detection unit (120) configured to detect installation of an external device that stores user information for authenticating a user and data input/output information specifying at least one input/output operation for predetermined data and to read the user information and the data input/output information; a control state monitoring unit (110) configured to monitor a control state of an industrial machine to be controlled; an input/output data determination unit (130) configured to compare the read user information and data input/output information with data access information relating to an access right for each user to the predetermined data and an access right for each control state and to determine whether an input/output operation for the predetermined data is able to be performed; and a data input/output unit (140) configured to execute an input/output operation for the predetermined data on the basis of a determination result of the input/output data determination unit (130).

### (Supplementary Note 2)

A control device according to another aspect of the present disclosure, wherein, when the input/output data determination unit (130) determines that an input/output operation is not able to be performed due to the control state, the input/output data determination unit (130) waits until a control state where the input/output operation is able to be performed is set, and notifies the data input/output unit (140) of the determination result of the input/output operation at a point in time when a control state where the input/output operation is able to be performed is set.

### (Supplementary Note 3)

A control device (1) according to another aspect of the present disclosure, further comprising an input/output result generation unit (150) configured to generate information related to input and output results including the determination result of the input/output data determination unit (130) and an execution result of the data input/output unit (140), wherein the data input/output unit (140) outputs the information related to the input and output results to the external device.

### (Supplementary Note 4)

A computer-readable recording medium having a program recorded thereon according to one aspect of the present disclosure, the program causing a computer to execute the following steps: a device detection step of detecting installation of an external device that stores user information for authenticating a user and data input/output information specifying at least one input/output operation for predetermined data and reading the user information and the data input/output information; a control state monitoring step of monitoring a control state of an industrial machine to be controlled; an input/output data determination step of comparing the read user information and data input/output information with data access information relating to an access right for each user to the predetermined data and an access right for each control state and determining whether an input/output operation for the predetermined data is able to be performed; and a data input/output step of executing an input/output operation for the predetermined data on the basis of a determination result in the input/output data determination step.

1. A control device comprising:
a device detection unit configured to detect installation of an external device that stores user information for authenticating a user and data input/output information specifying at least one input/output operation for predetermined data and to read the user information and the data input/output information;
a control state monitoring unit configured to monitor a control state of an industrial machine to be controlled;
an input/output data determination unit configured to compare the read user information and data input/output information with data access information relating to an access right for each user to the predetermined data and an access right for each control state and to determine whether an input/output operation for the predetermined data is able to be performed; and
a data input/output unit configured to execute an input/output operation for the predetermined data on the basis of a determination result of the input/output data determination unit.

2. The control device according to claim 1, wherein, when the input/output data determination unit determines that an input/output operation is not able to be performed due to the control state, the input/output data determination unit waits until a control state where the input/output operation is able to be performed is set, and notifies the data input/output unit of the determination result of the input/output operation at a point in time when a control state where the input/output operation is able to be performed is set.

3. The control device according to claim 1, further comprising an input/output result generation unit configured to generate information related to input and output results including the determination result of the input/output data determination unit and an execution result of the data input/output unit,
wherein the data input/output unit outputs the information related to the input and output results to the external device.

4. A computer-readable recording medium having a program recorded thereon, the program causing a computer to execute the following steps:
a device detection step of detecting installation of an external device that stores user information for authenticating a user and data input/output information specifying at least one input/output operation for predetermined data and reading the user information and the data input/output information;
a control state monitoring step of monitoring a control state of an industrial machine to be controlled;
an input/output data determination step of comparing the read user information and data input/output information with data access information relating to an access right for each user to the predetermined data and an access right for each control state and determining whether an input/output operation for the predetermined data is able to be performed; and
a data input/output step of executing an input/output operation for the predetermined data on the basis of a determination result in the input/output data determination step.
